(19) United States
(12) Patent Application Publication
(10) Pub. No.: US 2003/0222152 A1
(43) Pub. Date: Dec. 4, 2003

(54) Pre-paid debit & credit card

(76) Inventor: George E.S. Boley JR., Newark, NJ (US)

Correspondence Address: Matthew J. Peirce, Esq., Suite#1005, 330 S. 3rd Street, Las Vegas, NV, 89101, US

(21) Appl. No.: 10/447,536

(22) Filed: May 28, 2003

Related U.S. Application Data
(60) Provisional application No. 60/383,707, filed on May 28, 2002.

(51) Int. Cl. G06K 19/06

(52) U.S. Cl. 235/492

(57) ABSTRACT

A financial apparatus is disclosed. The financial apparatus would be a pre-paid debit and credit card that would have many “smart card” features incorporated into it. Included in the apparatus would be a read-only memory (ROM), random access memory (RAM), electronically erasable and programmable read-only memory (EEPROM), a clock, and input-output. A typical smart card might have an 8-bit operating at 5 megahertz, 256 to 1024 bytes of RAM, 6 to 24 kilobytes of ROM, 1 to 16 kilobytes of EEPROM, and perhaps an on-chip encryption module.

### BACKGROUND OF THE INVENTION

The present invention is that of a new and improved financial apparatus.

### II. DESCRIPTION OF THE PRIOR ART

U.S. Pat. No. 5,777,305, issued to Smith, discloses packaging and means for activating a prepaid debit card.

U.S. Pat. No. 5,637,845, issued to Kolls, discloses a system for monitoring and encoding pre-paid credit and debit cards.

U.S. Pat. No. 5,577,109, issued to Stimson, discloses a system allowing customers to make financial transactions using a prepaid card.

### III. SUMMARY OF THE INVENTION

The present invention is that of a new and improved financial apparatus. The financial apparatus would be a pre-paid debit and credit card that would have many “smart card” features incorporated into it. Included in the apparatus would be a read-only memory (ROM), random access memory (RAM), electronically erasable and programmable read-only memory (EEPROM), a clock, and input-output. A typical smart card might have an 8-bit operating at 5 megahertz, 256 to 1024 bytes of RAM, 6 to 24 kilobytes of ROM, 1 to 16 kilobytes of EEPROM, and perhaps an on-chip encryption module.

### IV. BRIEF DESCRIPTION OF THE DRAWINGS

FIG. 1 shows a front view of a “smart” credit card incorporating aspects of the present invention.

FIG. 2 shows a rear view of a “smart” credit card incorporating aspects of the present invention.

### V. DESCRIPTION OF THE PREFERRED EMBODIMENT

Priority is hereby claimed to application No. 60/383,707, filed on May 28, 2002.

A detailed description of the preferred embodiment and various alternative embodiments is disclosed below.

Product Description—How It Works

Detail Explanation of the Flow Chart, Security and Connectivity

Inside a Smart Card

The basic parts of a smart card will be familiar to any personal computer user. These include a Central Processing Unit (CPU), which performs calculations; a Read-Only Memory (ROM), which stores the operating system; Random Access Memory (RAM), which is used for temporary storage while calculations are performed; Electronically Erasable and Programmable Read-Only Memory (EEPROM), which stores data (such as account balances or encryption keys) that will be regularly changed; a Clock (which paces the rate at which instructions are processed); and Input-Output (IO)—via contacts which interface with a card reader (or, if the card is contact less, through induction or high-frequency radio transmission).

A typical smart card might have an 8-bit CPU operating at 5 megahertz, 256 to 1024 bytes of RAM, 6 to 24 kilobytes of ROM, 1 to 16 kilobytes of EEPROM, and perhaps an on-chip encryption module.

Some of the physical aspects of smart cards are shown in Table 2.

TABLE 2
Smart Card Basics
Under ISO 7816, a smart card has eight electrical contacts [21]:

C1: Power supply (VCC)
C2: Reset (RST)
C3: Clock (CLK)
C4: Reserved (RFU)
C5: Ground (GND)
C6: Programming voltage (VPP)
C7: Input/output (I/O)
C8: Reserved (RFU)

A transaction between the outside world and the card involves the following steps:

1. Activation of the contacts by the smart card reader

2. Resetting of the card by the reader

3. Answer-to-reset by the card

4. Optional selection of a protocol type

5. Processing of successive commands

6. Deactivation of the contacts by the card reader.

Input/output involves asynchronous characters transmitted in half-duplex mode. Each character is ten consecutive bits: a start bit, eight data bits, and an even parity bit. A short interval or “guard time” between successive characters allows for synchronization in the transmission.

The contacts connect to the internal parts of a chip. These are illustrated below:

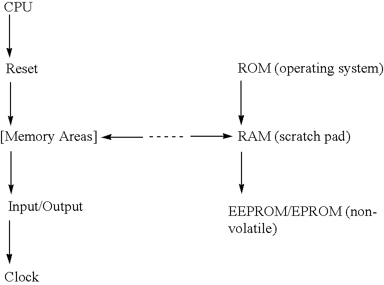

These are all contained in a single chip called a SPOM (self-programmable one-chip microcomputer). Europay, MasterCard, and Visa jointly created a set of smart card specifications (EMV '96) based on ISO 7816. [8] [9] [10] Visa then developed a specification based on EMV. [28]

In Table 2, notice contact C7, input/output (IO). This can be thought of as the smart card's serial port. Information is transferred into, or out of, the smart card here, one bit at a time. The data packets through which smart cards talk to the outside world are called Application Protocol Data Units (APDU). The structure of these is defined by ISO 7816. An APDU is either a command sent to the smart card, or a reply from the smart card. The terminal, which always initiates communication, is the master and the smart card is the slave. The communication interface is half duplex, typically operating at 9600 baud. (Half duplex means that the card and the terminal take turns sending signals to each other.)

C1 and C5 (supply voltage and ground) are used to power the card. Power is supplied by the card terminal (card reader). In the EMV '96 specifications, the supply voltage is 5V, plus or minus a half volt. (When you see an article in a Usenet hacking group that explains how to “hack” a card using 21 volts, you are being conned. That level voltage may fry the card. Such articles are posted by smart card manufacturers and pranksters.) C6, external programming voltage, is rarely used anymore.

Smart Card Security

To prevent counterfeiting or misuse, a smart card relies on the access to the data residing in EEPROM for its own internal applications being controlled by a secure operating system residing in ROM. The EEPROM data might include a newly generated 1024-bit RSA key, or updateable information about the cardholder (if the card is used for identification), or the current cash balance on the card, while the secure operating system might include ROM cryptographic routines.

If one could change the authentication information on a card—by altering the RSA key or the identification information—then one could masquerade as another person. It one could change the cash balance on a card, then one could rip-off merchants or the card issuer. A well-designed card system will involve various security measures. The smart card may authenticate the card holder through a password (or passwords) stored in EEPROM. The user must enter the correct password before the other functions of the smart card chip are unlocked.

The card may authenticate the card reader (the external world) by generating a random number and sending it to the reader. The reader has to encrypt the random challenge with a shared encryption key and return the result to the card. The card then compares the returned result with its own encryption before agreeing to communicate with the reader. The card reader (the external world) may also authenticate the card's identity by sending a random challenge (number) to the card. The card is then required to sign the number with its own private key (of a private key/public key pair) and return it to the external world for verification.

The integrity of data exchanged between the card and the outside world can be verified through a MAC (message authentication code). The MAC is a number that is calculated based on 1) the data itself, 2) an encryption key, and 3) a random number. If data has been altered (for any reason, including transmission errors), the MAC will not verify. Alternatively, if the chip has sufficient memory and processing power, the data can be verified through a digital signature. Some important advances in applied cryptography have been smart-card driven. The digital-signature algorithm (DSA) recently adopted by the U.S. government, and now widely used around the world, is based on the concept of an Schnorr signature [27], which was first announced as a smart card application. (Most smart cards currently implement RSA signatures, however, preferring to conserve resources through the use of the Chinese Remainder Theorem. [26])

Alongside interoperability, security is a leading smart card issue. Before one contemplates storing $50,000 on a smart card [15], one needs to think a lot about security. Attacks on security can take the form of attacks on the smart card's software or hardware, or both simultaneously. Is it possible to create tamper-proofs or at least tamper-resistant, modules?

That tamper-resistance is more difficult that it looks was shown by Ross Anderson and Markus Kuhn, who cracked the Dallas DS5002FP Secure Microcontroller, described at the time by one European signals intelligence agency as the most secure processor available on general sale. The processor is Intel 8051 compatible and is used in financial transaction terminals and pay-TV access systems.

“The attack requires only a normal personal computer, a special read-out circuit built from standard electrical components for less than US$100, and a logic analyzer test clip for around US$200. It was performed in a student hardware laboratory . . . ” [1]

They created a protocol attack, which exploits the fact that one of the chip's block ciphers operates on 8-bit blocks. Anderson and Kuhn were able to brute force (i.e. find the encryption key by trying every possible variation) the encrypted data by matching inputs and outputs from the card in a complex way they describe in detail.

Protocol failure is one problem. Other reports [2] also discusses differential fault analysis, chip-rewriting attacks, and memory remanence attacks.

An example of differential fault analysis might entail subjecting a chip, which runs at 5 megahertz to small bursts of 20 megahertz. The clock frequency (contact C3, in Table 2) speedup would be applied with the intention of making the chip skip or improperly execute an instruction as the chip is running through a program sequence. Ross and Kuhn illustrate with examples involving RSA and DES.

Chip rewriting attacks involve identify specific memory cells in ROM or EEPROM and altering their contents. Single bits in ROM can be overwritten with a laser cutter microscope, while those in EEPROM can be altered through two microprobing needles. Of course, the information garnered this way has to be worth the effort—but it may be if it gives access to the right computer or building or bank account.

When values have been stored in computer memory for a long period of time, it is virtually impossible to erase them without leaving magnetic traces that can be used to recover the values. This is the basis of memory remanence attacks. Many banks have ATMs with a security module developed by IBM and revised by VISA. Inside the security module are key-encrypting (“master”) keys. These keys are used to encrypt PIN keys as well as other encryption keys, such as the encryption keys used to communicate with other banks. If the security module is opened under the wrong circumstances, it erases these master keys. But this erasure isn't really secure, since there are now well-known techniques for recovering the original values. (The same, of course, applies to any computer hard disk that has stored the same information in the same place for a period of time.)

All of these attacks assume the encryption algorithm itself is secure. But that may not be true. The encryption cipher used in the SIM (subscriber identification module) in GSM (mobile) telephones was cracked in a day by two researchers at the University of California, Berkeley. The SIM is a small smart card with encryption functions, which stores subscriber-specific information separate from the phone itself.

It is important to keep the security issues associated with smart cards (and hence with money stored in, or accessed by, smart cards) in perspective. Paper money, such as U.S. currency, for example, is easily counterfeited (despite the recent rash of security—as well as surveillance—measures added to various dollar bill denominations). That counterfeiting doesn't take place more often is due to the great resources of the U.S. Secret Service—an enforcement arm of the U.S. Treasury. Smart card cash issuers don't have these same resources. A start-up operation will not benefit from the huge cash flow that seigniorage grants the U.S. Federal Reserve (seigniorage being the difference between the cost of issuing currency and the interest earned from the government bonds purchased with it). Thus, living on a limited budget, creators of private currencies have to approach security with applied intelligence.

Connectivity

An application program talks to the card terminal and the card itself through the ISO 7816-defined data packets called Application Protocol Data Units (APDU), which were mentioned previously. The program sends commands with an onion structure. First, the command must be one the card supports, such as “generate a 1024-bit RSA key).” This is wrapped inside an ISO command packet that tells the terminal how to talk to the card. Then the ISO command packet is wrapped inside an Smart Card-based packet for communicating with the card reader.

Smart cards used in the European banking system can authorize transactions off-line when cardholders enter their PINs. A more recent application is Mondex, which is an electronic wallet system that allows electronic currency to pass from hand to hand without redepositing. Mondex cards can also store several national currencies.

Integrated Circuit (IC) Memory Cards. IC memory cards can hold up to 1-4 KB of data, but have no processor on the card with which to manipulate that data, Thus, they are dependent on the card reader (also known as the card-accepting device) for their processing and are suitable for uses where the card performs a fixed operation.

The Flow Chart (Description)

Phase 1 Thru 4

Phase 1 The flowchart consists of two-way data being shared in the developmental stages of Application Protocol Data Units (APDU) by the Manufacture (SCM) and the Charge Card Company (CCC). This two-way data being shared information is the foundation of the card format and application. This product primarily is application based using the microchip and the card reader as secondary service hardware. This is the only phase were the developers will have contact, the upward flow of data is to update and upgrade the product from information gathered in the market place concerning the card, is use, and it's flaws. The ($) Currency sign shown is the purchase of the card for sales from the manufacture to the Charge Card Company (CCC), that price is described below in unit only.

Phase 2 Although the Global Network Platform (GNP) in the diagram is sitting to the left side of the Charge Card Company (CCC), the Global Network Platform (GNP) is part of the internal structure of the financial institution. (See Changes) This is the same premise for the Card Reader Servers (CRS) located next to the Global Central Banking System (GCBS) icon. Data being shared here will be used solely by the Charge Card Company (CCC) and the Global Central Banking System (GCBS), for the integration facilitation of the PPD-CC format to the BANKS. The whole internal infrastructure process of Phase 2 is depicted by a yellow box!

Phase 3 The BANKS and their designated institutions will then service the PPD-CC to their Banking Global Netwroks (BGN) shown as USA, EURO, AFRICA and ASIA. The parameters are listed below.

Phase 4 The BANKS then shuffle the process to their Banking Global Netwroks (GBN) all over the world shown as USA, EURO, AFRICA and ASIA. These networks then sell this format to their Regional and Local Carries (Bank Branches) that put the product in the hand of the consumer.

The Product

(Color Coding Is Unique to this Method of Currency Exchange)

We offer and support five types of PPD &CC/MEC products:

The pre-paid debit in charge card service will be based on two stable currencies USD and the British pound only. (1) The Basic card shall hold the value of $1.00 to $500 and will be represent by a blue box with text. (2) The Standard card offered shall hold a dollar value of $501 to $1,500 and shall be represented by a yellow box with text. (3) The Premium card shall hold a dollar value of $1,501 to $2,500 and shall be represented by a red box with text. (4) The Gold card shall hold a value of $2,501 to $9,999 dollars and will be represented by the standard gold box with text. (5) A corporate Platinum card that has a limit of $10,000 to $500,000 max. USD or British Pound equivalent, for trading and international businesses exchange shall be represented by the standard platinum box with text.

This system of color-coding the cards will give businesses the ability to speculate as to the purchasing potential of the consumer. More importantly, this system will give those consumers who are illiterate the ability to decipher what card they want to purchase and use just the by the color code.

Addendum:

For additional security each MEC Format will scan a User's (Customer[s]) picture on the back of the card. For additional Identification Purposes this process would be a manual one once the funds have been loaded on the card by the issuer of the card.

The Client Purchase Process

The process of purchasing our MEC format would not be possible any other way due to technology and equipment field parameters.

Smart Card Manufacturing and Production

1. The smart card manufacturer will work with the application software company to complete the following steps.

a. Programming and developing uniform (MONDEX type unique software) Application Protocol Standard (APS) software that will service the new hard ware and Float system network already established by world-class credit card institutions such as; American Express Travelers Checks. This software will be integrated into the card reader hardware and the (IC) Stored Value Memory Card chip to fit our five service formats.

b. Development of a standard Electronically Erasable and Programmable Read-Only Memory (EEPROM) application software of our five formats for the integration process onto the financial institutions global server network. These protocols and new platforms would be mandatory to handle our application and service of product.

c. Working jointly with a major credit card company in establishing a new global support system, this new workload will maintain and support all new application protocol information being sent to the financial institutions' global platform network. It is important to establish that these applications being developed do have universal compatibility, so that a customer from Africa would use the same operating procedures, as a customer from the United States, Asia or Europe.

Moreover, it is important that the global network server process this information in the same way.

2. The applications will have fixed functions that will program certain parameters to the PPD-CC (MEC) making the card like a CD-R® (Compact Disc) so that once the data is written to the (IC) Stored Memory Card that data cannot be tampered with or changed. This will enable the Charge card company who uses this card to (a) input the

3. Value Memory Card that data cannot be compromised or changed. This will enable the Banks using this card to (a) input the precise data from their application to perform specifications; (b) control end user application and, (c) capture valuable customer target marketing research data relevant to the local economics, geographic and demographic markets.

This will always give the Banks and the Software Company the ability to keep improving on the card formats and the parameters for better service and improved performance of the MEC.

Additionally, this gives businesses insight about customer buying patterns and spending behaviors.

4. The hardware or Point of Sale (POS) device or terminal (i.e. card readers or mobile phones) manufacturers will cooperate with the software company issuing all security encryption codes, card tamper protocols, Transaction Authorization Code (TAC), RA (Return Authorization) codes, batch & stock digits, DSA, phone numbers and Charge Card numbers.

In order for the merchant to be paid, the card reader must send the Transaction Authorization Code (TAC) to the network platform. This code then debits accounts payable from the banks or pool funds mangers.

5. The Banks will be responsible for working with the local mobile & telecommunication companies in securing and providing the software manufacturers the local and toll phone numbers needed in the event of lost and or thief. The phone number will be on the receipt given to the customer at the time of (POS) purchase and used to cancel the card, for a fee, in the event loss or theft. The turn around time for remaining balance refund would be 30-45 days.

6. The Banks and or Pool Funds Managers will hold all reserves and will dispense reserves to banks monthly, after the RA code has been giving and processed. (*).

More importantly, the Banks end or Pool Funds Managers will be responsible for working with the domestic and international settlements house for local and cross boarder currency exchange.

Once the application software has been developed and the platform has been set to the five MEC formats, the smart card and POS terminal manufactures will sell the cards and systems to the banks and or pool funds management organization.

Banks

The uniform application software developed will directly affect the cost of the MEC. Each MEC format will have two sets of numbers written on the back of the IC memory card, a multi-digit batch alpha-numeric and a stock number. This information will be put on track sheets and signed for by all receiving banking institutions. All formats being sold to banks will be inputted into the manufacturer's banks and Charge Company's database mainframe computer server, as Charge Card number in use or ready for use.

Banks will pay for the network system and the manufacturing of the payment schema.

The Basic MEC format from our data is the customer usable and re-usable card format. This MEC Basic card format will range from $1.00 to $500 USD or its equivalent. This charge card amount gives customers the flexibility to add any dollar amount within this given range to MEC format. All MEC formats will have value ranges of dollar amounts for purchase. The dollar amount directly affects the card's fee and purchase MEC price. (See Sect. 2.4)

Each bank will exercise its discretion regarding fees for the Corporate Platinum Card. This card can be value at between $10,000.00 to $100,000.00 USD or its equivalent. The Banks may, for example, charge an additional 10% on the first $5,000.00 USD or its equivalent for inter-commerce processing and documentation fees.

Banks Are Responsible for:

1. The security for the purchased MEC.

2. All track sheets needed by Charge Card Company.

3. The dispensing of reserve balance on the MEC to the customer and returning the used MEC card with RA (Return Authorization) code to the Charge Card Company for credit of reserves.

4. The card reader will give bank officials what type of ID has to be used at the time of purchase of the MEC service.

5. Banks are also responsible for the activation of the MEC, this is their only function. The card reader will already have the set parameters for ID as followed:

A. Government: Visa Number & Country (mandatory for international travelers, and must be put on track sheets)

B. U.S., State and Federal ID

C. Motor Operation Permit (Driver License)

D. Customer choice of Personal Identification Number (PIN)

6. All (IC) MEC format will be held by the bank. No card reading or programming dispenser will be accessible to the customer.

7. Working with Mobile operators to issue them license as currency depositors ONLY (Pool Funds Managers). A consumer, for example, could go to a mobile phone operator and credit currency to his or her MEC or e-MEC account and the mobile phone operator would then complete the transfer of funds to the merchant at point of sale (POS).

After activation a receipt is giving to the customer that has the activation code and the local or toll number for cancellation purposes in the event of loss or thief. This receipt is solely the responsibility of the customer. The bank, however, must retain a copy of the receipt for its records as a means of tracking customers' information.

To ensure the MEC success the card has to be accepted and returned to any Bank anywhere in the world for refund of reserve(s), that is why is it important the track sheets be used and secured!

Note: Using any of these methods would make it mandatory for the banks to write down on the track sheet by the batch and stock number, which form of ID was used by letter shown above and the Activation code.

The Customer

Should follow the tips giving for Charge Card and ATM use, bring the currency and start using our MEC and return it when they are done.

Note: It is the sole responsibility of the consumers to protect themselves and the MEC purchased by retaining the receipt giving to them by the Bank, without this information it will not be possible to service them at all, not even the return of the reserve(s), with or without ID).

It is the sole responsibility of customers to show their ID) to all merchants requesting it for purchases.

Revenue

The hardware and software manufacturers will gain revenue income from the sale of their card readers for this type of application and preventive maintenance (servicing) of such POS units. The Banks and or Pool Funds Managers will gain greater income from monthly activation service fees and transaction fees.

Notes: Additional revenue will be generated from consumers based on monthly activation service fees. This fee will apply to a balance on the MEC that carry over every month.

The Future of (MEC) Money Express Card*

The present product profile and marketing summary are just the beginning of the MEC service process. In the near future, the MEC card will be available through Mobile Operators. Banks will also have the ability to limit their overhead by working with Mobile Operators in selling e-MEC (electronic-Money Express Card) to customers through mobile or cellular networks. Such a system with software and hardware would require the use of mobile operators acting as pool funds managers and or deposit institutions. This is optimal for complete banking and sales market penetration and usage. This system would then use secure mobile text messaging and the customer's mobile number instead of the MEC charge numbers to purchase goods and services at POS thus creating the mobile phone to act as the POS device instead of the card reader. This would link MEC to a mobile phone by card number or mobile number. Point of reference if you lose the phone you don't lose the currency linked to that number! It secured by your PIN!

Banks, Pool Funds Managers and Mobile Operators debiting the funds from their customers mobile, checking or savings account as with regular debit card transactions through POS terminals for a fee limits overhead but most importantly reduces banking liability of excess outstanding funds and the movement of paper currency (local money).

Infrastructure & Systems

This system would be established where the current economic infrastructure of Banks, Pool Funds Managers and Mobile Operators and POS card dispenser units are utilized and networked together through the banking system in the same location.

In the future, Banks, Pool Funds Managers and Mobile Operators will be combined with POS Smart Card readers units promoting the true concept of the 24-hour access availability.

This type of infrastructure and system are based primarily in countries with stable, sustained economic growth. The pre-paid marketplace will experience transitional growth in five to seven years in parts of the world with no established system of credit and is therefore convenient for use un-banked populations.

Marketing & Promotion MEC

Based on our present formats, banks will have the ability to use the MEC to advertise and promote their institution by placing the MEC logo on a small part of the banking institution's card as do the Charge Card Companies. Banks will also use their respective banking institution's logo for the background of the Card. (Example the present debit Charge Cards used by financial institutions today, i.e. VISA Check Card). This type of co-production and promotion would be used with specific MEC formats issues to customers who travel out of country or overseas!

This co-production or promotion with banks and charge companies would be beneficial to relationships and networks with the domestic and International settlement houses for local and cross boarder currency exchange.

Cash & Carry

The system of cash and carry to the banks by customers who are purchasing our MEC service will be used in parts of the under-developed/developing world where individuals do not have checking or saving accounts to the debited but still need our service (Un-Banked Populations). This is the core and unique concept of our present marketing and product proposals. As the economic and financial infrastructure in a given under-developed country develops, the system of cash and carry will be minimized but never truly obsolete.

Using this system and all operating parameters, the MEC service will proceed in the same way as mentioned in the marketing summary and product profile. The forecast mentioned in this insert is an add-on for those networks that already have some type of reliable payment schema system in place that will make the transition to MEC service more readily.

Moreover, the Application PPD-CC (MEC) Is Unique in that this Application is Disposable or Reloadable, like Pre-Paid Phone Cards and or Cell Phones.

### The Flow Chart Description (See Reports & Graphs)

Phase 1 through 4

Phase 1 The flowchart consists of two-way data being shared in the developmental stages of the Application Protocol Data Units (APDU) by the Payment Transaction Company (PTC) i.e. Software Company and the Banks and or Pool Funds Managers. This two-way data being shared information is the foundation of the card format and application. This product primarily is application based using the microchip and the card reader (POS) devise as secondary service hardware. The phase were the PTC will have contact, the upward flow of data is to update and upgrade the product from information gathered in the market place concerning the card, its use, and its flaws. The ($) Currency sign shown is the purchase of the card for sales from the banks to the consumers.

Phase 2 The Local Network Platform (LNP) is a primary part of the internal structure of the financial institution. This network works with Banks and Pool Fund management companies and PTC for managing accounts. This is the same premise for the Point of Sale (POS) located next to the Local Network Platform (LNP) icon. Data being shared here will be used solely by the Payment Transaction Company (PTC) and the Central Banking System (CBS), for the integration facilitation of the PPD-CC format to the BANKS. The whole internal infrastructure process of Phase 2 is depicted by a yellow box!

Phase 3 The consumer then purchases the MEC schema for use and reuse of MEC Services.

Phase 4 The introduction of Mobile Operators (MO) as part of the e-MEC system for transferring money and purchasing goods and or services is an optimal development of MEC product. With such an introduction Banks and or Pool Funds Managers and or Mobile Operators (MO) will be able to process transactions of the sales of goods and or services with the use of a consumer's mobile number with or without the MFC product format (card) available. The consumer would have to use his PIN to complete the purchase.

[image]

Addendum:

For additional security each MEC Format will scan a Users (Customer[s]) picture on the back of the card. For additional Identification Purposes

The Client Purchase Process

Scenario

First: Users walks up to the ATM machine that will carry out a series of functions for the customer to buy the MEC Format. With currency in hand the ATM will ask the customer to begin the process, by touching the screen. The customer then depresses the icon for MEC Card purchase.

Second: The ATM will prompt the customer to select what type of card the customer wishes to purchase, then the ATM gives the customer the five formats to choose from. The customer chooses Basic, the ATM machine then prompts the customer to load the currency into the ATM. After the customer load in the set currency amount, the ATM will prompt the customer to manually type in the exact amount again then click OK.

Thirdly: Once the amount has been determined by the customer the ATM machine will then prompt the customer to look at the screen where a digital camera will take a picture a half inch in size of the customer and scanned onto the back of the MEC Card in the Top right hand corner. This process will take 60 seconds. (This will happen while the ATM machine is prompting the customer for the exact amount value.)

Fourthly: After the picture is taken and scanned onto the back of the MEC Format the card will then be dispensed to the customer.

The final phase would be that the ATM machine would prompt the customer to put the MEC formatted card into the card reader so the card reader will them program and authorize the MEC card for the exact dollar amount paid for by the customer. The ATM will then prompt the customer to remove the card from the ATM after the information has been written to the smart chip. Once the ATM finalizes this transaction the information will then be send to the financial institutions global network system platform so the card will be ready for immediate use. I estimate that this whole process should take three to three and a half minutes (3-3½ minutes). like a regular ATM transaction.

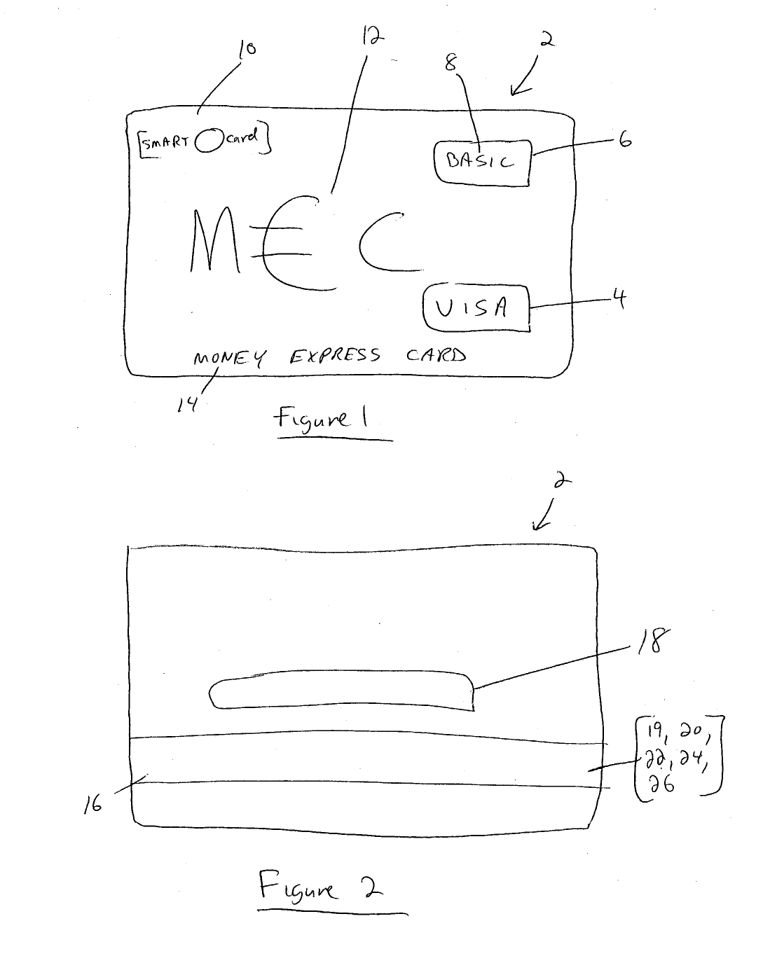

FIG. 1 shows a front view of a “smart” credit card 2 incorporating aspects of the present invention, while FIG. 2 shows a rear view of a “smart” credit card incorporating aspects of the present invention. Smart card 2 has two surfaces, a front surface and a rear surface, the card having a rectangular shape, the card having two ends, a left end and a right end, the card having two sides, a top side and a bottom side, the card having four corners comprising an upper right corner, an upper left corner, a lower right corner, and a lower left corner.

Smart card 2 has a charge card logo 4 attached to the front surface of the card in the lower right corner of the card. Smart card 2 also has a type logo 6 attached to the front surface of the card in the upper right corner of the card. Smart card 2 also has a word 8 located within the type logo 6 to indicate the type of card that a particular smart card 2 would be. Furthermore, smart card 2 has a “smart card logo” 10 attached to the front surface of the card 2 in the upper left corner of the card 2. Smart card 2 also has the letters “MEC” 12 attached to the front surface of the card in the center of the card.

Smart card 2 also has the words “MONEY EXPRESS CARD” 14 placed below the placement of the letters “MEC” 12 on the front surface of the card. Furthermore, smart card 2 has a magnetic stripe 16 located on the rear surface of the card 2 and a signature line 18 located on the rear surface of the card 2 for signature by an individual.

Within the magnetic stripe 16, card 2 has a plurality of “smart card” features. These features include, but are not limited to, an amount of read-only memory 19, an amount of random access memory 20, an amount of electronically erasable and programmable read-only memory 22, a clock 24, and input-output mechanisms 26. The amount of memory or characteristics for each of these features is disclosed elsewhere in this application.

An individual would be allowed to purchase the present invention with any denomination. If a user chose to purchase the present invention with a value between $1.00 and $500.00, the type logo would be blue and the word in the type logo would read “BASIC.” If a user chose to purchase the present invention with a value between $501.00 and $1,500.00, the type logo would be yellow and the word in the type logo would read “STANDARD.” If a user chose to purchase the present invention with a value between $1,501.00 and $2,500.00, the type logo would be red and the word in the type logo would read “PREMIUM.” If a user chose to purchase the present invention with a value between $2,501.00 and $9,999.00, the type logo would be gold and the word in the type logo would read “GOLD.” If a user chose to purchase the present invention with a value of $10,000.00 or higher, the type logo would be platinum and the word in the type logo would read “PLATINUM.”

What I claim as my invention is:

1. A prepaid debt and charge apparatus comprising:
(a) a card having two surfaces, a front surface and a rear surface, the card having a rectangular shape, the card having two ends, a left end and a right end, the card having two sides, a top side and a bottom side, the card having four corners comprising an upper right corner, an upper left corner, a lower right corner, and a lower left corner,
(b) a charge card logo attached to the front surface of the card in the lower right corner of the card,
(c) a type logo attached to the front surface of the card in the upper right corner of the card,
(d) a word located within the type logo to indicate the type of card,
(e) a “smart card logo” attached to the front surface of the card in the upper left corner of the card,
(f) the letters “MEC” attached to the front surface of the card in the center of the card,
(g) the words “MONEY EXPRESS CARD” placed below the placement of the letters “MEC” on the front surface of the card,
(h) a magnetic stripe located on the rear surface of the card,
(i) a signature line located on the rear surface of the card for signature by an individual,
(j) a plurality of smart card features incorporated into the magnetic stripe on the rear surface of the card,
(k) wherein an individual could purchase a prepaid debt and charge apparatus with a specific limit as chosen by an individual.

2. A prepaid debt and charge apparatus according to claim 1 wherein the plurality of smart card features incorporated into the magnetic stripe on the rear surface of the card further comprises:
(a) an amount of read-only memory,
(b) an amount of random access memory,
(c) an amount of electronically erasable and programmable read-only memory,
(d) a clock, and
(e) input-output mechanisms.

3. A prepaid debt and charge apparatus according to claim 2 wherein the type logo attached to the front surface of the card in the upper right corner of the card has a blue color.

4. A prepaid debt and charge apparatus according to claim 3 wherein the word located within the type logo to indicate the type of card would be “BASIC.”

5. A prepaid debt and charge apparatus according to claim 3 wherein the possible range in value of the apparatus is between one dollar ($1.00) and five hundred dollars ($500.00).

6. A prepaid debt and charge apparatus according to claim 2 wherein the type logo attached to the front surface of the card in the upper right corner of the card has a yellow color.

7. A prepaid debt and charge apparatus according to claim 3 wherein the word located within the type logo to indicate the type of card would be “STANDARD.”

8. A prepaid debt and charge apparatus according to claim 3 wherein the possible range in value of the apparatus is between five hundred and one dollars ($501.00) and fifteen hundred dollars ($1,500.00).

9. A prepaid debt and charge apparatus according to claim 2 wherein the type logo attached to the front surface of the card in the upper right corner of the card has a red color.

10. A prepaid debt and charge apparatus according to claim 3 wherein the word located within the type logo to indicate the type of card would be “PREMIUM.”

11. A prepaid debt and charge apparatus according to claim 3 wherein the possible range in value of the apparatus is between fifteen hundred and one dollars ($1,501.00) and twenty-five hundred dollars ($2,500.00).

12. A prepaid debt and charge apparatus according to claim 2 wherein the type logo attached to the front surface of the card in the upper right corner of the card has a gold color.

13. A prepaid debt and charge apparatus according to claim 3 wherein the word located within the type logo to indicate the type of card would be “GOLD”

14. A prepaid debt and charge apparatus according to claim 3 wherein the possible range in value of the apparatus is between twenty-five hundred and one dollars ($2,501.00) and nine thousand nine hundred and ninety-nine dollars ($9,999.00).

15. A prepaid debt and charge apparatus according to claim 2 wherein the type logo attached to the front surface of the card in the upper right corner of the card has a platinum color.

16. A prepaid debt and charge apparatus according to claim 3 wherein the word located within the type logo to indicate the type of card would be “PLATINUM.”

17. A prepaid debt and charge apparatus according to claim 3 wherein the possible range in value of the apparatus is ten thousand dollars ($10,000.00) or greater.
